(19) United States
(12) Patent Application Publication
(10) Pub. No.: US 2017/0282612 A1
(43) Pub. Date: Oct. 5, 2017

(54) LIQUID EJECTING APPARATUS AND ASSEMBLING METHOD OF LIQUID EJECTING APPARATUS

(71) Applicant: SEIKO EPSON CORPORATION, Tokyo (JP)

(72) Inventors: Yoji TAKAHASHI, Matsumoto-shi (JP); Osamu HARA, Matsumoto-shi (JP); Eiji KUMAI, Matsumoto-shi (JP)

(21) Appl. No.: 15/507,794

(22) PCT Filed: Aug. 27, 2015
(86) PCT No.: PCT/JP2015/004311

§ 371 Date: Mar. 1, 2017

(30) Foreign Application Priority Data
Sep. 1, 2014 (JP) 2014-176875

(51) Int. Cl. B41J 13/076; B41J 29/02; B41J 27/12; B41J 29/04

(52) U.S. Cl. CPC B41J 13/076; B41J 29/04; B41J 29/02; B41J 27/12; B41J 2/215

(57) ABSTRACT

There is provided a liquid ejecting apparatus including: an unwinding unit that holds a roll-shaped medium and unwinds the held medium; an ejecting unit that ejects liquid onto the medium unwound from the unwinding unit; a winding unit that winds the medium onto which the liquid is ejected; and a base member to which the unwinding unit and the winding unit are attached.

### TECHNICAL FIELD

The present invention relates to a liquid ejecting apparatus and an assembling method of the liquid ejecting apparatus.

### BACKGROUND ART

An ink jet printer as an example of a liquid ejecting apparatus can perform recording on a medium by ejecting ink, as an example of liquid, from a recording head onto the medium such as a recording sheet. As the ink jet printer, there is an ink jet printer including a sending device that sends a medium by unwinding the medium from a roll around which the medium is wound in a roll shape; a recording head that performs recording on the medium sent by the sending device; and a winding device that winds the recorded medium in a roll shape (for example, refer to PTL 1).

### CITATION LIST

### Patent Literature

PTL 1: JP-A-2012-139822

### SUMMARY OF INVENTION

### Technical Problem

In the ink jet printer in the related art, the sending device and the winding device are attached to a main body frame via different components, respectively. In this manner, if there are lots of components between the components relating to transportation of the medium, the attachment error of each component is accumulated, and thus it is difficult to improve the positional accuracy of the medium in a transport path of the medium.

### Solution to Problem

The invention can solve at least the problem described above, and can be implemented as the following forms or application examples.

### Application Example 1

There is provided a liquid ejecting apparatus including: an unwinding unit that holds a roll-shaped medium and unwinds the held medium; an ejecting unit that ejects liquid onto the medium unwound from the unwinding unit; a winding unit that winds the medium onto which the liquid is ejected; and a base member to which the unwinding unit and the winding unit are attached.

In the liquid ejecting apparatus according to the application example, the unwinding unit and the winding unit are attached to a common member such as the base member. Therefore, it is possible to improve the positional accuracy of the medium in the transport path of the medium.

### Application Example 2

The liquid ejecting apparatus described above, further includes: a transporting unit that is disposed between the unwinding unit and the winding unit and transports the medium.

In the application example, the transporting unit is positioned between the unwinding unit and the winding unit, and therefore, it is possible to transport the medium between the unwinding unit and the winding unit.

### Application Example 3

In the liquid ejecting apparatus described above, in a plan view of the liquid ejecting apparatus, the ejecting unit is positioned between the unwinding unit and the winding unit.

In the application example, the ejecting unit is positioned between the unwinding unit and the winding unit, and therefore, it is easy to preferably obtain the weight balance between the unwinding unit and the winding unit with the ejecting unit as a reference.

### Application Example 4

The liquid ejecting apparatus described above, further includes: a main body portion that includes the ejecting unit; and an angle adjusting unit that adjusts an angle of the main body portion.

In the application example, the angle of the main body portion can be adjusted by the angle adjusting unit, and therefore, the angle of the main body portion with respect to the medium can be adjusted.

### Application Example 5

The liquid ejecting apparatus described above, further includes: a main body portion that includes the ejecting unit, in which the main body portion is attached to the base member.

In the application example, the main body portion including the ejecting unit is attached to the base member, and therefore, it is possible to improve the positional accuracy of the ejecting unit with respect to the medium.

### Application Example 6

The liquid ejecting apparatus described above, further includes: a medium supporting portion that supports the medium, in which the medium supporting portion is attached to the base member.

In the application example, the medium can be supported by the medium supporting portion, and therefore, it is possible to improve the positional accuracy of the medium. Further, the medium supporting portion that supports the medium is attached to the base member, and therefore, it is possible to further improve the positional accuracy of the medium.

### Application Example 7

In the liquid ejecting apparatus described above, a heater is provided to the medium supporting portion.

In the application example, the heater is provided to the medium supporting portion, and therefore, it is possible to heat the medium.

### Application Example 8

The liquid ejecting apparatus described above, further includes: a tension adjusting unit that adjusts tension applied to the medium, in which the tension adjusting unit is attached to the base member.

In the application example, the tension applied to the medium can be adjusted by the tension adjusting unit. Further, the tension adjusting unit is attached to the base member, and therefore, it is possible to improve the positional accuracy of the tension adjusting unit with respect to the medium.

### Application Example 9

There is provided an assembling method of a liquid ejecting apparatus including an unwinding unit that holds a roll-shaped medium and unwinds the held medium; an ejecting unit that ejects liquid onto the medium unwound from the unwinding unit; and a winding unit that winds the medium onto which the liquid is ejected, the method including: attaching the unwinding unit and the winding unit to a base member.

In the assembling method of a liquid ejecting apparatus according to the application example, the unwinding unit and the winding unit are attached to a common member such as the base member. Therefore, it is possible to improve the positional accuracy of the medium in the transport path of the medium.

### BRIEF DESCRIPTION OF DRAWINGS

FIG. 1 is a perspective view illustrating a recording device according to an embodiment.

FIG. 2 is a sectional view when the recording device according to the embodiment is cut along an YZ plane.

FIG. 3 is a perspective view illustrating a support base portion and a tension applying mechanism according to the embodiment.

FIG. 4 is an exploded perspective view illustrating a configuration of the support base portion according to the embodiment.

FIG. 5 is an exploded perspective view illustrating a configuration of a supporting leg according to the embodiment.

FIG. 6 is a perspective view illustrating the support base portion according to the embodiment.

FIG. 7 is an exploded perspective view illustrating a configuration of the supporting leg according to the embodiment.

FIG. 8 is a sectional view when the recording device according to the embodiment is cut along an YZ plane.

FIG. 9 is a perspective view illustrating a leg portion according to the embodiment.

FIG. 10 is a perspective view illustrating the leg portion and a base plate according to the embodiment.

FIG. 11 is a rear view when a main body portion according to the embodiment is seen from a Y axis direction.

FIG. 12 is a perspective view illustrating the support base portion and the main body portion according to the embodiment.

FIG. 13 is a perspective view illustrating the support base portion, the main body portion, and the tension applying mechanism according to the embodiment.

FIG. 14 is a perspective view illustrating the recording device according to the embodiment.

### DESCRIPTION OF EMBODIMENTS

A recording device 1, as an example of a liquid ejecting apparatus, according to an embodiment is described with reference to the drawings. In each drawing, in order to illustrate each configuration to be visually recognized, the scales of the configuration or members are illustrated differently. The recording device 1 of the embodiment is, specifically, an ink jet printer.

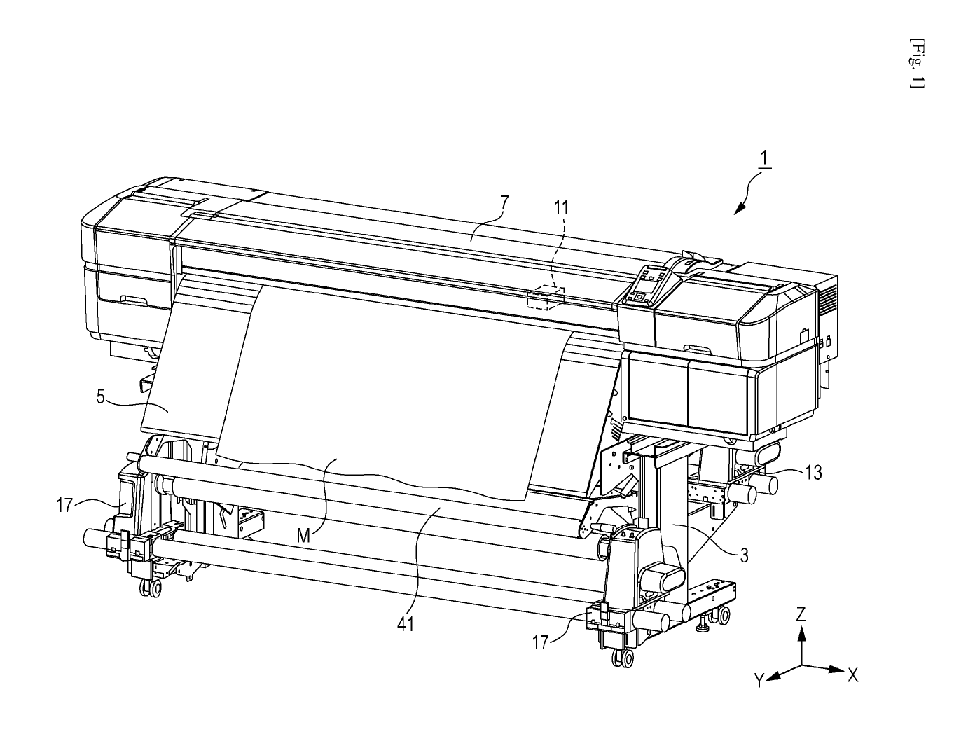

As illustrated in FIG. 1, the recording device 1 according to the embodiment includes a support base portion 3, a guide portion 5, and a main body portion 7. In addition, in FIG. 1, X, Y, and Z axes, which are coordinate axes orthogonal to each other, are assigned. Also in subsequent drawings, the X, Y, and Z axes are assigned, if necessary. In the embodiment, a state, in which the recording device 1 is arranged on a horizontal plane (an XY plane) defined by the X axis and the Y axis, is a usage state of the recording device 1. The Z axis is an axis orthogonal to the horizontal plane. In the usage state of the recording device 1, a Z axis direction is a vertical direction.

The support base portion 3 supports the guide portion 5 and the main body portion 7, and is mounted on or fixed to a floor or the like. The guide portion 5 supports a medium M on which recording is performed by a recording head 11. The main body portion 7 is positioned above the guide portion 5 in the Z axis direction, and straddles the guide portion 5 in an X axis direction. Therefore, the guide portion 5 and main body portion 7 cross each other. In the recording device 1, the recording can be performed on the medium M with ink by ejecting ink as ink droplets from the recording head 11 while changing the relative position of the recording head 11 and the medium M in a plan view. In addition, the recording head 11 is an example of an ejecting unit. Ink is an example of liquid. That is, the liquid ejecting apparatus includes the ejecting unit that can eject liquid onto the medium M that is unwound from an unwinding unit.

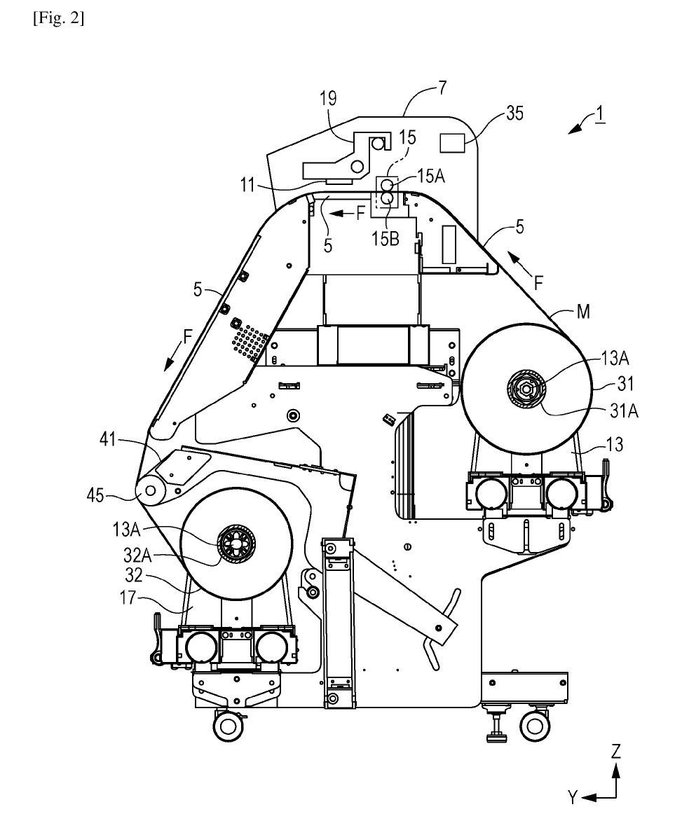

As illustrated in FIG. 2, which is a sectional view when the recording device 1 is cut along the YZ plane, the recording device 1 includes a sending device 13 as an example of the unwinding unit, a transporting device 15 as an example of a transporting unit, and a winding device 17 as an example of a winding unit. In addition, the main body portion 7 of the recording device 1 includes a carriage 19. The recording head 11 is mounted to the carriage 19. In the main body portion 7, the carriage 19 is configured to move along the X axis (FIG. 1) in a reciprocating manner. The carriage 19 can move along the X axis in a reciprocating manner by the power supplied from a motor (not illustrated). In short, the main body portion 7 includes an ejecting unit.

As illustrated in FIG. 2, the medium M is mounted to the sending device 13 in a state of being a roll 31. In the roll 31, the medium M, on which the recording is to be performed, is wound around a tubular core tube 31A. The sending device 13 includes a motor (not illustrated) and a holding portion 13A that holds the core tube 31A of the roll 31 in a rotatable manner. In the sending device 13, the roll 31 is rotated by driving the holding portion 13A by using the power supplied from the motor. Accordingly, the medium M is unwound from the roll 31 to be sent to the guide portion 5. In other words, the liquid ejecting apparatus includes the unwinding unit that can hold the roll-shaped medium M and can unwind the held medium M.

The transporting device 15 includes a motor (not illustrated) and a pair of a roller 15A and a roller 15B. The roller 15A and the roller 15B are configured to be rotatable in a state where outer peripheries thereof are in contact with each other. In the transporting device 15, the pair of the roller 15A and the roller 15B is driven to be rotated by the power supplied from the motor. In addition, the pair of the roller 15A and the roller 15B is driven to be rotated in a state where the medium M is interposed between the roller 15A and the roller 15B, and therefore, the medium M is transported along a transport path F. A direction along the transport path F is a transport direction of the medium M. In short, the liquid ejecting apparatus includes the transporting unit that is arranged between the unwinding unit and winding unit, and transports the medium M.

The winding device 17 winds the medium M as a roll 32. In the roll 32, the medium M, on which the recording is performed, is wound around a tubular core tube 32A. The winding device 17 includes a motor (not illustrated) and the holding portion 13A that holds the core tube 32A of the roll 32 in a rotatable manner. Further, the holding portion 13A of the winding device 17 has the same configuration as that of the holding portion 13A of the sending device 13. In the winding device 17, the roll 32 is rotated by driving the holding portion 13A by using the power supplied from the motor. Accordingly, the winding device 17 can wind the medium M, which is sent from the side of the guide portion 5, as the roll 32. In other words, the liquid ejecting apparatus includes the winding unit that can wind the medium M onto which liquid is ejected.

The guide portion 5 is configured of a plurality of members, which are disposed along the transport path F of the medium M. Each member corresponds to a medium supporting portion that supports the medium M. That is, the liquid ejecting apparatus includes a plurality of medium supporting portions. Specifically, there are three medium supporting portions of the medium supporting portion that is arranged in a region on the upstream side of the recording head 11 in the transport path F (upstream-side medium supporting portion); the medium supporting portion that is arranged in a region including the recording head 11 in the transport path F (platen); and the medium supporting portion that is arranged in a region on the downstream side of the recording head 11 in the transport path F (downstream-side medium supporting portion). However, the number of medium supporting portions may be two or less or may be 4 or more. The guide portion 5 has a length that straddles the main body portion 7 along the Y axis. The guide portion 5 is provided at a position overlapping the main body portion 7. The recording head 11 faces the guide portion 5. The medium M that is unwound from the roll 31 by the sending device 13 passes through a space between the guide portion 5 and the main body portion 7 and reaches the winding device 17. The path from the sending device 13 to the winding device 17 via the space between the guide portion 5 and the main body portion 7 is the transport path F of the medium M in the recording device 1. The transporting device 15 is provided between the sending device 13 and the winding device 17 in the transport path F. Moreover, the transporting device 15 is positioned between the sending device 13 and the recording head 11 in the transport path F. The medium M that is unwound from the roll 31 by the sending device 13 is transported toward the downstream side in the transport path F by the transporting device 15 in a state of being supported by the guide portion 5.

The recording head 11 is provided on the downstream side of the transporting device 15 in the transport path F. In the transport path F, the medium M faces the recording head 11. Therefore, in the recording device 1, the recording head 11 can perform recording on the medium M in the transport path F. The winding device 17 is provided on the downstream side of the guide portion 5 in the transport path F. The medium M, on which recording is performed by the recording head 11, is wound as the roll 32 by the winding device 17 on the downstream side of the guide portion 5 in the transport path F.

In this manner, in the recording device 1, it is possible to perform recording on the medium M with a roll-to-roll form. In the recording device 1, the operation of the recording on the medium M is controlled by a control unit 35.

That is, in the recording device 1, driving of each of the sending device 13, the transporting device 15, the carriage 19, the recording head 11, and the winding device 17 is controlled by the control unit 35. In the present embodiment, in a plan view when the recording device 1 is seen from a −Z axis direction, the recording head 11 is positioned between the sending device 13 and the winding device 17. In this configuration, it is easy to obtain the weight balance between the sending device 13 and the winding device 17 with the recording head 11 as a reference. Accordingly, it is possible to improve the stability of the recording device 1, and is easy to improve the quality of recording on the medium M.

In addition, in the recording device 1, a tension applying mechanism 41 is provided between the guide portion 5 and the winding device 17 in the transport path F. The tension applying mechanism 41 is an example of a tension adjusting unit.

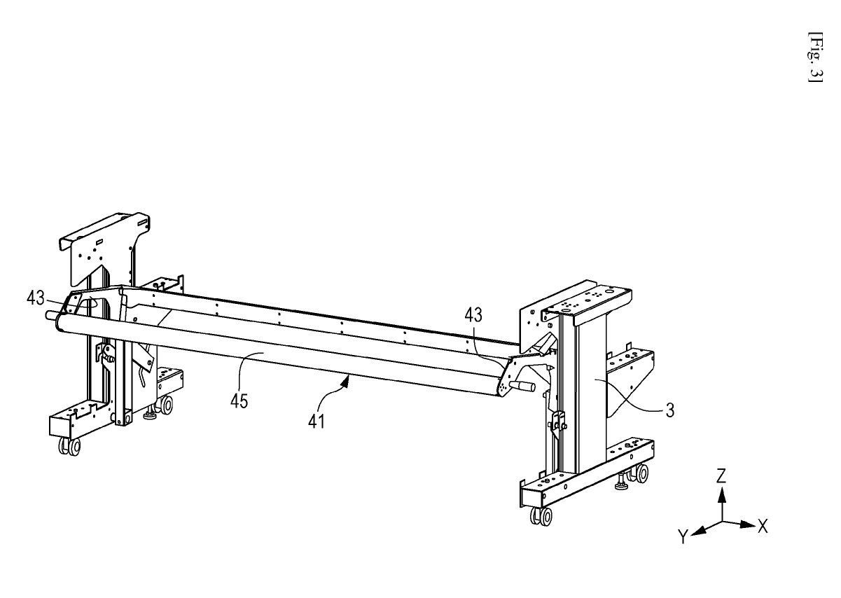

As illustrated in FIG. 3, the tension applying mechanism 41 includes a pair of arm members 43 that is rotatably supported by the support base portion 3, and a tension roller 45 that is rotatably supported by the pair of arm members 43. The tension roller 45 has an axis length longer than the assumed maximum width of the medium M along the X axis. As illustrated in FIG. 2, the tension roller 45 presses the medium M in a state of being in contact with the surface of the medium M, which is supported by the guide portion 5. Accordingly, the medium M is applied with the tension between the guide portion 5 and the winding device 17 in the transport path F. As a result, it is easy to prevent the occurrence of the looseness of the roll 32 when the winding device 17 winds the medium M. In short, the liquid ejecting apparatus includes the tension adjusting unit that can adjust the tension applied to the medium M.

In addition, in the recording device 1, the guide portion 5 that is in a region on the downstream side of the recording head 11 in the transport path F, of the guide portion 5, is attached to the base plate 73. Here, the base plate 73 is an example of a base member that is a base to which a plurality of components are attached. In other words, the medium supporting portion that is in the area on the downstream side of the recording head 11 is attached to the base member. In addition, the medium supporting portion in another region may be attached to the base member. In a case where a plurality of medium supporting portions are provided, if at least one medium supporting portion is attached to the base member, it is possible to obtain an effect of improving the positional accuracy of the medium M. Further, in the medium supporting portion that is in the region on the downstream side of the recording head 11 in the transport path F, a heater (not illustrated) is provided. The heater can heat the medium M via the guide portion 5. In this manner, it is possible to promote the drying of ink that is ejected onto the medium M from the recording head 11. Therefore, in the recording device 1, the medium M can be wound as the roll 32 by the winding device 17 after the ink ejected onto the medium M is sufficiently dried. As a result, it is easy to prevent the quality of recording on the medium M from being degraded. The heater may be provided in the medium supporting portion in anther region.

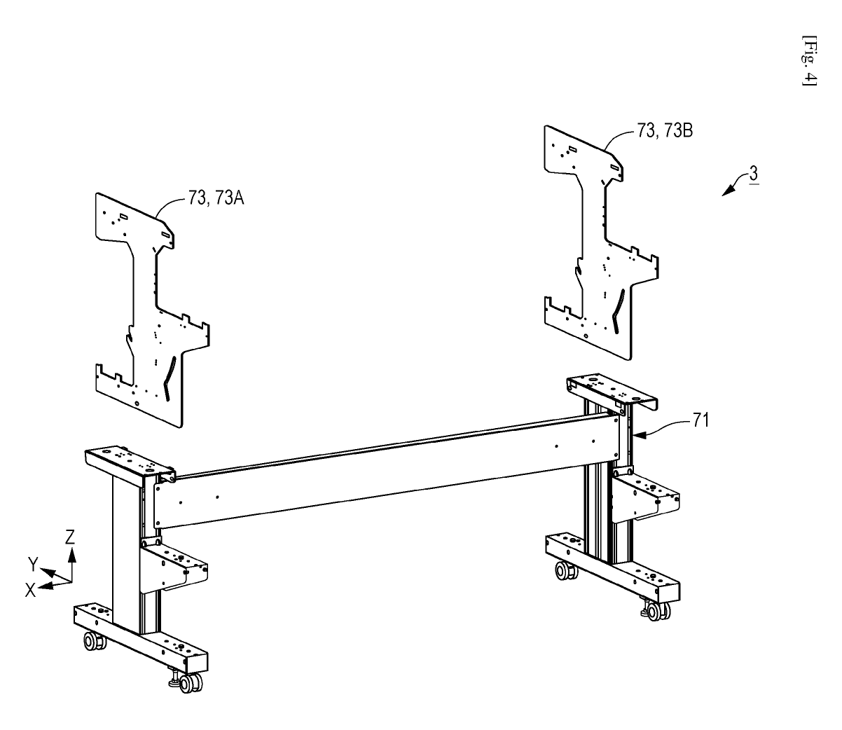

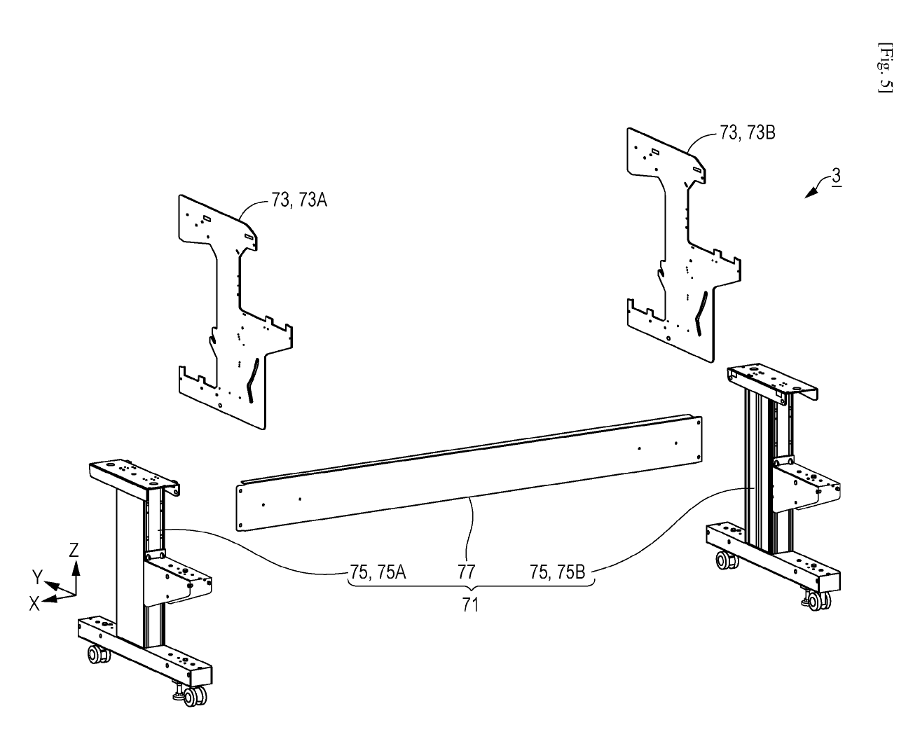

As illustrated in FIG. 4, the support base portion 3 includes a supporting leg 71 and two base plates 73. In the following description, in a case where the two base plates 73 are distinguished from each other, the two base plates 73 are indicated as the base plate 73A and the base plate 73B, respectively. The two base plates 73 are attached to the supporting leg 71. The two base plates 73 are arranged parallel to each other along the X axis. As illustrated in FIG. 5, the supporting leg 71 includes two leg portions 75 and a connecting plate 77. In the following description, in a case where the two leg portions 75 are distinguished from each other, the two leg portions 75 are indicated as the leg portion 75A and the leg portion 75B, respectively.

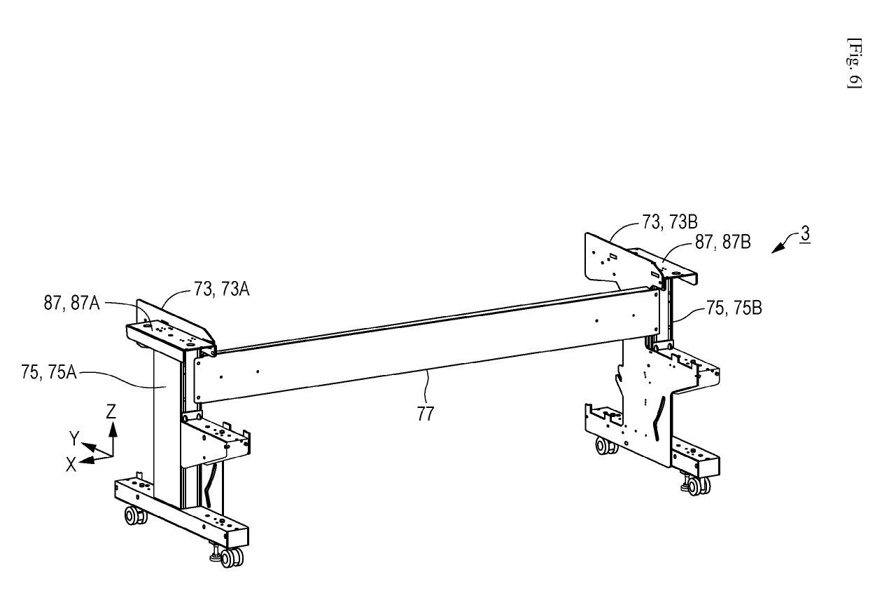

The two leg portions 75 are arranged parallel to each other along the X axis. The two leg portions 75 are connected to each other through the connecting plate 77. As illustrated in FIG. 6, the two base plates 73 are positioned between the two leg portions 75. The base plate 73A of the two base plates 73 is attached to the leg portion 75A. In addition, the base plate 73B of the two base plates 73 is attached to the leg portion 75B.

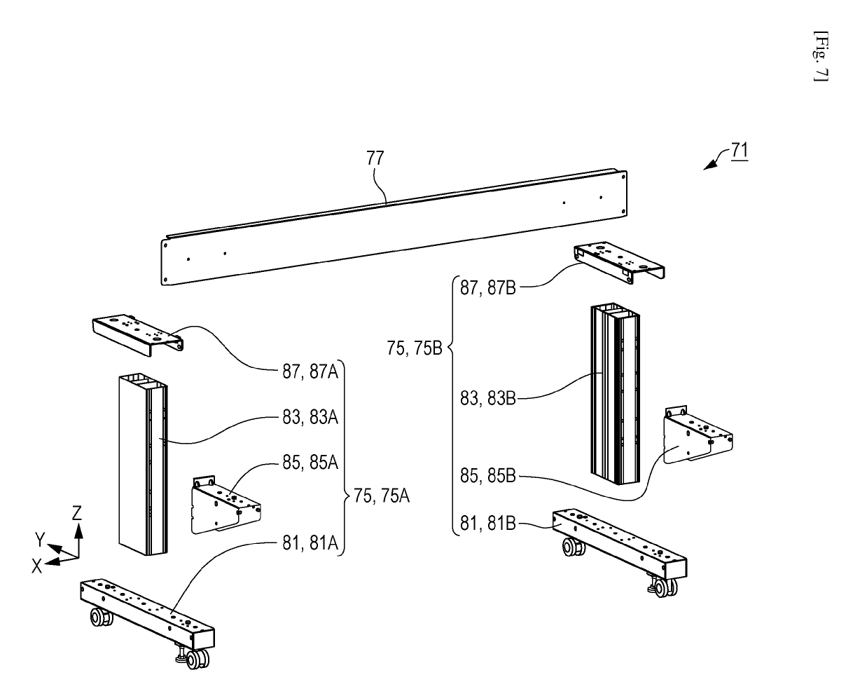

As illustrated in FIG. 7, each leg portion 75 includes a foot portion 81, a support 83, an arm portion 85, and a top plate 87. In the following description, the two foot portions 81 are distinguished for each leg portion 75, the foot portion 81 of the leg portion 75A is indicated as the foot portion 81A, and the foot portion 81 of the leg portion 75B is indicated as the foot portion 81B. In addition, the two supports 83 are distinguished for each leg portion 75, the support 83 of the leg portion 75A is indicated as the support 83A, and the support 83 of the leg portion 75B is indicated as the support 83B. In a case where the two arm portions 85 are distinguished for each leg portion 75, the arm portion 85 of the leg portion 75A is indicated as the arm portion 85A, and the arm portion 85 of the leg portion 75B is indicated as the arm portion 85B. In addition, in a case where the two top plates 87 are distinguished for each leg portion 75, the top plate 87 of the leg portion 75A is indicated as the top plate 87A, and the top plate 87 of the leg portion 75B is indicated as the top plate 87B.

The foot portion 81 is arranged on a surface (for example, floor face) on which the recording device 1 (FIG. 1) is provided.

The foot portion 81 extends along the Y axis. The support 83 is attached to the foot portion 81 in the Z axis direction. The support 83 extends along the Z axis. The arm portion 85 is attached to the support 83 on the −Y axis direction side. The arm portion 85 protrudes in the −Y axis direction from the support 83. The top plate 87 is attached to an end portion of the support 83 on a side opposite to the foot portion 81, that is, an end portion of the support 83 on the Z axis direction side. The connecting plate 77 is attached to the support 83 of each of the two leg portions 75. The connecting plate 77 is attached to the support 83 on the Z axis direction side farther than the arm portion 85 in the −Y axis direction side of the support 83.

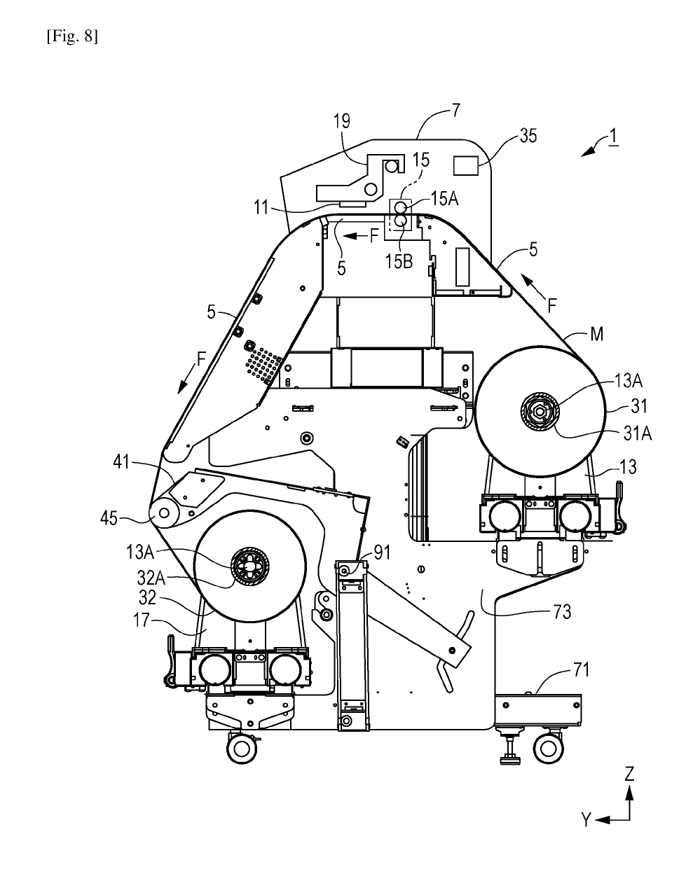

As illustrated in FIG. 8, which is the sectional view when the recording device 1 is cut along the YZ plane, the sending device 13, the guide portion 5, the tension applying mechanism 41, and the winding device 17 are supported by the supporting leg 71 via the base plate 73. The base plate 73 is continuous between the sending device 13, the guide portion 5, the tension applying mechanism 41, and the winding device 17. The base plate 73 is an example of a continuous member. In other words, the tension adjusting unit is attached to the base member. The arm member 43 of the tension applying mechanism 41 is configured to be rotatable with respect to the base plate 73 with a supporting point 91 as a fulcrum. In the tension applying mechanism 41, it is possible to adjust the tension applied to the medium M by adjusting the rotational angle of the arm member 43 with respect to the base plate 73. In short, the liquid ejecting apparatus includes the base member to which at least the unwinding unit and winding unit are attached. That is, the unwinding unit and winding unit are attached to a common member such as the base member. Therefore, in the transport path F of the medium M, it is possible to improve the positional accuracy of the medium M.

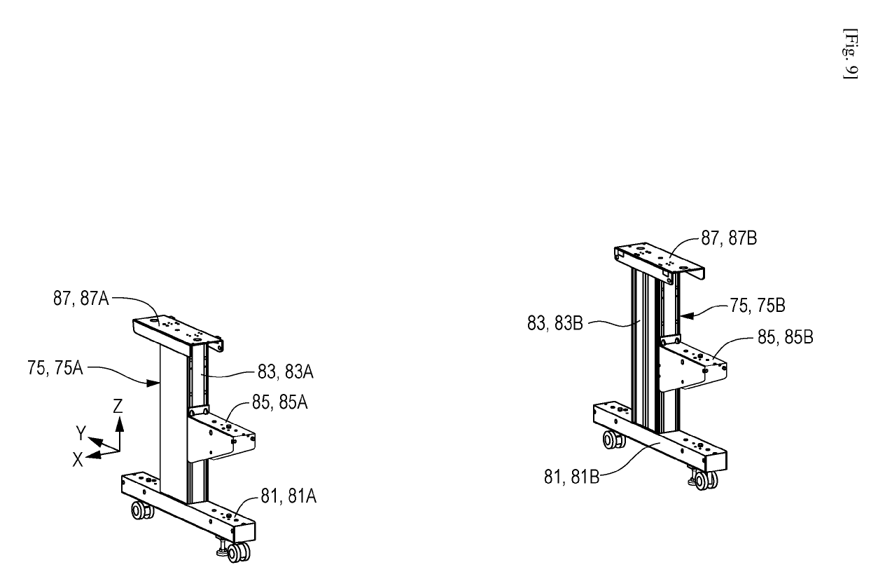

An assembling method of the recording device 1 is described. The assembling method of the recording device 1 is broadly classified into a process of assembling the support base portion 3, a process of attaching the main body portion 7 to the support base portion 3, and a process of attaching the sending device 13, the tension applying mechanism 41, and the winding device 17 to the support base portion 3. Here, an example of the process of assembling the support base portion 3 is described. As illustrated in FIG. 9, in the process of assembling the support base portion 3, first, the leg portion 75A and the leg portion 75B are assembled. At this time, in the leg portion 75, in the assembling order of the foot portion 81, the support 83, the arm portion 85, and the top plate 87, any of them may be assembled first or last. As an example of the assembling order, the support 83 is attached to the foot portion 81, the arm portion 85 is attached to the support 83, and then the top plate 87 is attached to the support 83. As another example of the assembling order, the arm portion 85 and the top plate 87 are attached to the support 83, and the support 83 is attached to the foot portion 81.

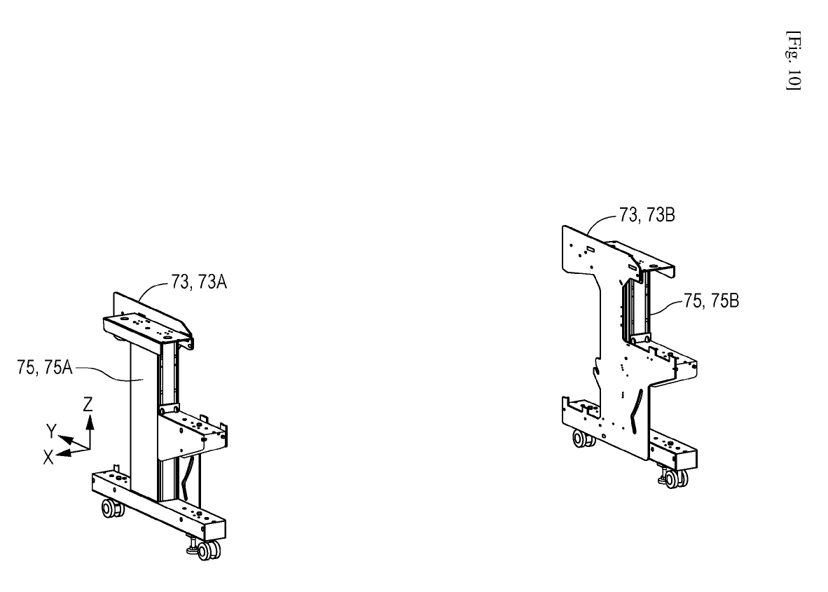

Next, as illustrated in FIG. 10, the base plate 73 is attached to each of the leg portion 75A and the leg portion 75B. At this time, the attachment position of the base plate 73 to the leg portion 75 is determined according to the top plate 87 as a reference. In addition, the support base portion 3 is assembled by connecting the leg portion 75A and the leg portion 75B via the connecting plate 77 (FIG. 6). An order of connecting the leg portion 75A and the leg portion 75B via the connecting plate 77 before the base plate 73 is attached to the leg portion 75 may be adopted. In such an order, the base plate 73 is attached to the leg portion 75 after the supporting leg 71 is assembled by connecting the leg portion 75A and the leg portion 75B via the connecting plate 77.

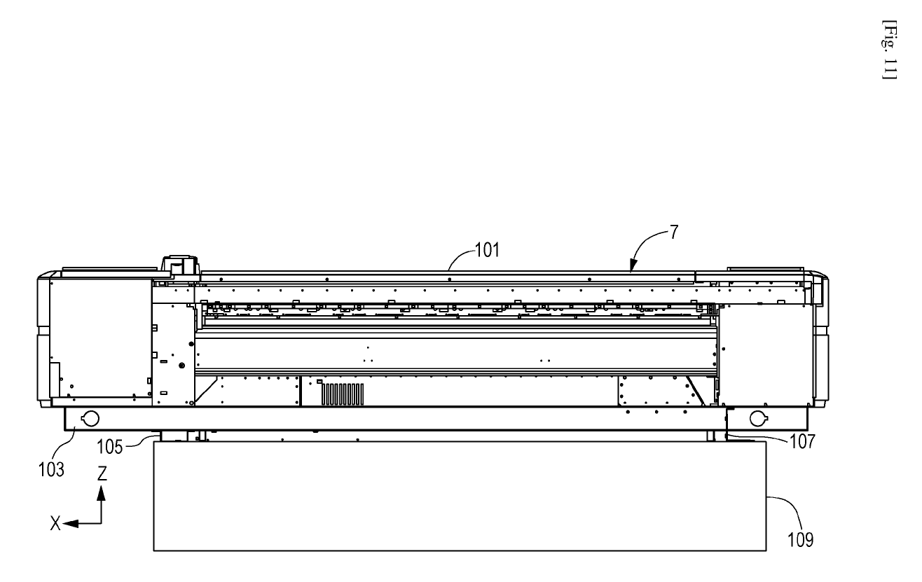

Next, in the process of attaching the main body portion 7 to the support base portion 3, the main body portion 7 is attached to the support base portion 3. Here, the main body portion 7 is described. As illustrated in FIG. 11, which is a rear view when the main body portion 7 is seen from a Y axis direction, the main body portion 7 includes a main body case 101, a base portion 103, a connecting member 105, and a connecting member 107. The recording head 11, the transporting device 15, and the carriage 19 are accommodated in the main body case 101. The base portion 103 is provided in −Z axis direction side of the main body case 101. The base portion 103 has a columnar external appearance, and extends along the X axis. The base portion 103 supports the main body case 101 in the Z axis direction.

The connecting member 105 and the connecting member 107 are provided on a side of the base portion 103 opposite to the side of the main body case 101, that is, provided in the −Z axis direction side of the base portion 103. The connecting member 105 and the connecting member 107 are arranged parallel to each other along the X axis with a gap therebetween. The connecting member 105 and the connecting member 107 are provided at positions facing the top plate 87A and the top plate 87B of the support base portion 3 (FIG. 6) along the Z axis. In the embodiment, the connecting member 105 of the main body portion 7 (FIG. 11) faces the top plate 87A of the support base portion 3 (FIG. 6) along the Z axis. In addition, the connecting member 107 of the main body portion 7 (FIG. 11) faces the top plate 87B of the support base portion 3 (FIG. 6) along the Z axis.

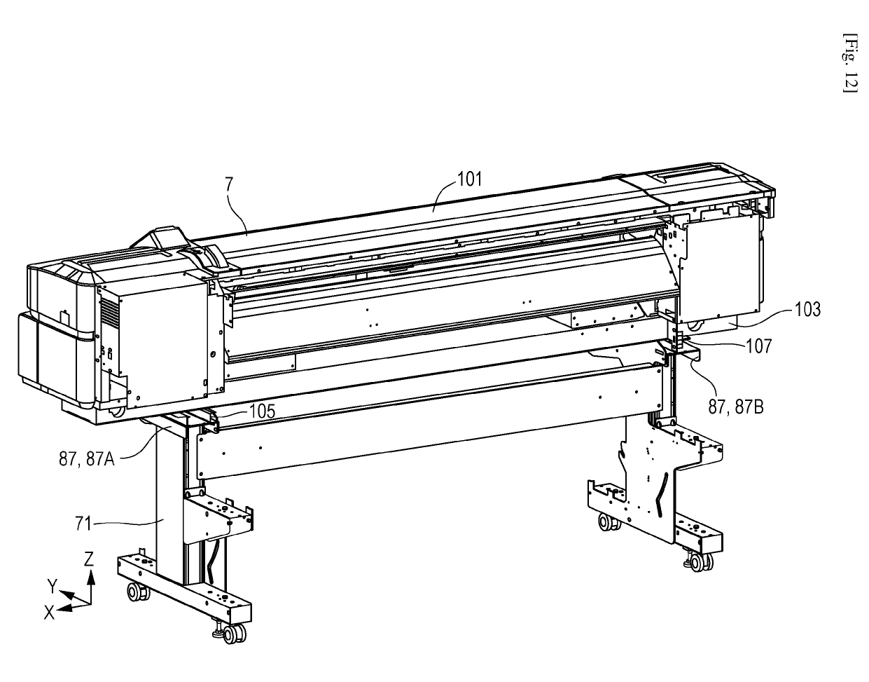

In the process of attaching the main body portion 7 to the support base portion 3, in a state where the connecting member 105 faces the top plate 87A and the connecting member 107 faces the top plate 87B, the connecting member 105 is attached to the top plate 87A by using a bolt, a nut, and the like. In the same manner, the connecting member 107 is attached to the top plate 87B by using a bolt, a nut, and the like. Accordingly, as illustrated in FIG. 12, the main body portion 7 is attached to the support base portion 3.

In the embodiment, in a stage before the process of attaching the main body portion 7 to the support base portion 3, the inclination of the main body portion 7 is adjusted (hereinafter, referred to as the inclination adjustment). As illustrated in FIG. 11, in the inclination adjustment of the main body portion 7, a surface plate 109 is utilized. In the surface plate 109, the dimension accuracy, the surface roughness, and the flatness of the surface are minutely processed with high accuracy. In the inclination adjustment of the main body portion 7, the main body portion 7 is mounted on the surface plate 109. Then, in a state where the main body portion 7 is mounted on the surface plate 109, the gap amount between the base portion 103 and the connecting member 107 is adjusted, and thereby the inclination of the main body portion 7 with respect to the surface plate 109 is caused to be in an allowable range. Accordingly, the inclination of the main body portion 7 with respect to the surfaces of the connecting member 105 and the connecting member 107 facing the top plate 87 is adjusted to be in the allowable range. The gap amount between the base portion 103 and the connecting member 107 can be adjusted by, for example, a screw mechanism (not illustrated) provided between the base portion 103 and the connecting member 107. In addition, the connecting member 107 is an example of an angle adjusting unit. In other words, the liquid ejecting apparatus includes the angle adjusting unit that can adjust the angle of the main body portion 7.

In this manner, in the embodiment, after the inclination of the main body portion 7 with respect to the surfaces of the connecting member 105 and the connecting member 107 facing the top plate 87 is adjusted to be in the allowable range, the main body portion 7 is attached to the support base portion 3. That is, in the embodiment, it is possible to adjust the angle of the main body portion 7 with respect to the supporting leg 71. Accordingly, the inclination of the main body portion 7 with respect to the top plate 87 can be suppressed to be extremely small. In the embodiment, the position of the base plate 73 is determined according to the top plate 87 as a reference. Therefore, in the embodiment, the positional accuracy of the base plate 73 with respect to the main body portion 7 can be maintained to be high.

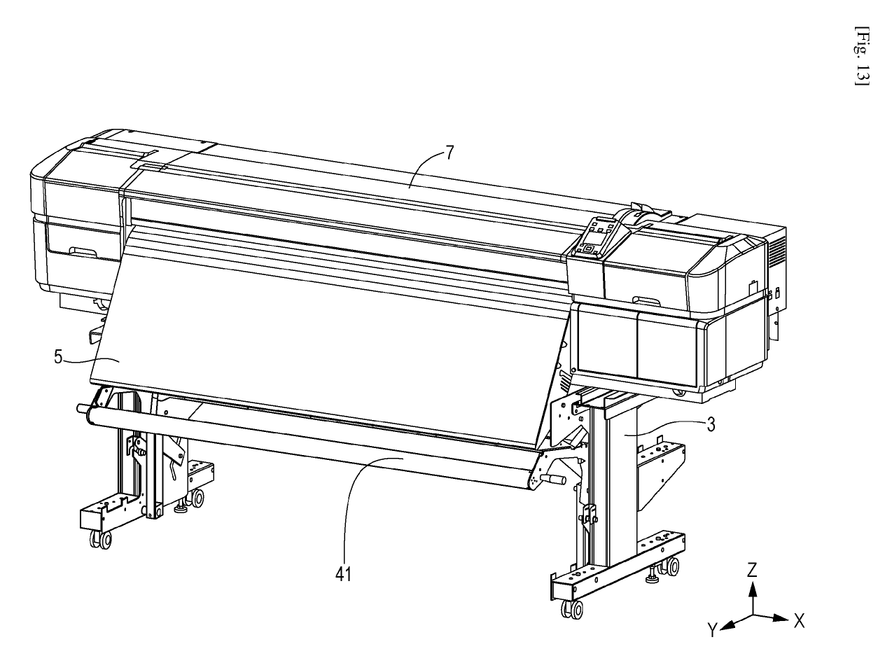

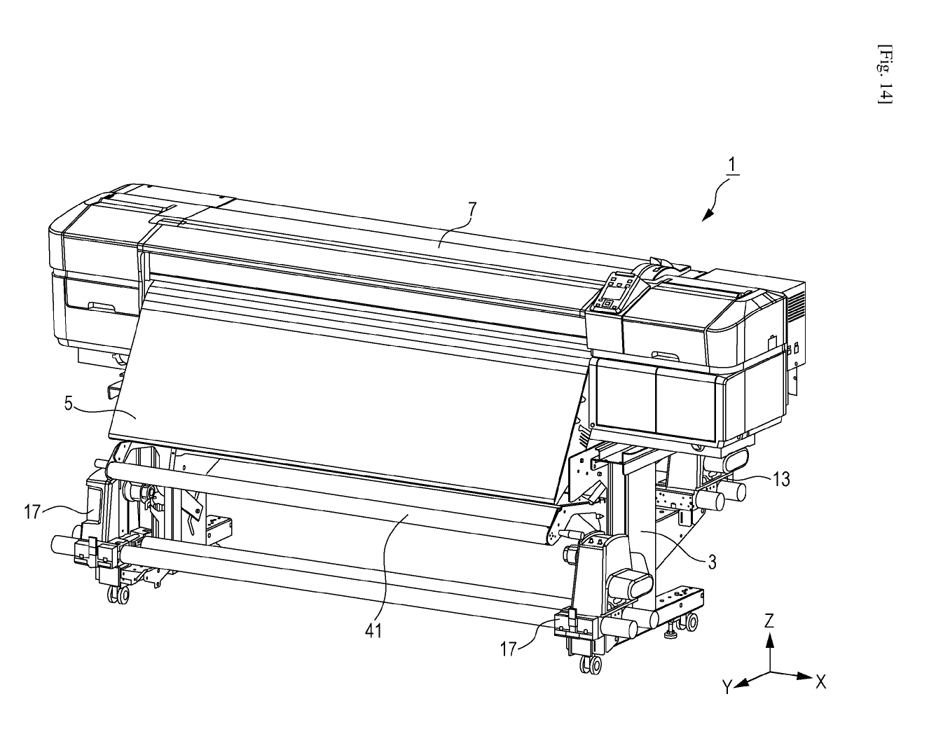

Next, in the process of attaching the sending device 13, the tension applying mechanism 41, and the winding device 17 to the support base portion 3, first, as illustrated in FIG. 13, the tension applying mechanism 41 is attached to the support base portion 3. Then, as illustrated in FIG. 14, the sending device 13 and the winding device 17 are attached to the support base portion 3. In this manner, the assembly of the recording device 1 is completed.

In the example described above, an order is adopted in which the process of attaching the sending device 13, the tension applying mechanism 41, and the winding device 17 to the support base portion 3 is performed after the process of attaching the main body portion 7 to the support base portion 3 is performed. However, any of the processes may be performed first or last. That is, an order may be adopted in which the process of attaching the main body portion 7 to the support base portion 3 is performed after the process of attaching the sending device 13, the tension applying mechanism 41, and the winding device 17 to the support base portion 3 is performed.

Further, in the process of attaching the sending device 13, the tension applying mechanism 41, and the winding device 17 to the support base portion 3, in the attaching order of the sending device 13, the tension applying mechanism 41, and the winding device 17, any of them may by attached first or last. That is, an order can be adopted in which the sending device 13 and the winding device 17 are attached to the support base portion 3, and then the tension applying mechanism 41 is attached to the support base portion 3. In addition, an order can be adopted in which any one of the sending device 13 and the winding device 17 is attached to the support base portion 3, the tension applying mechanism 41 is attached to the support base portion 3, and then the other of the sending device 13 and the winding device 17 is attached to the support base portion 3. In short, the assembling method of a liquid ejecting apparatus is an assembling method of a liquid ejecting apparatus including an unwinding unit that holds a roll-shaped medium M and unwinds the held medium M; an ejecting unit that ejects liquid onto the medium M unwound from the unwinding unit; and a winding unit that winds the medium M onto which the liquid is ejected, and is an assembling method of attaching the unwinding unit and the winding unit to a base member. In the assembling method, the unwinding unit and winding unit are attached to a common member such as the base member. Therefore, in the transport path F of the medium M, it is possible to improve the positional accuracy of the medium M.

In addition, a location where the assembly of the recording device 1 is carried out is not limited. As the location where the assembly of the recording device 1 is carried out, for example, various locations such as a location where the recording device 1 is installed (hereinafter, referred to as the installation location), or a factory where the recording device 1 is manufactured (hereinafter, referred to as the manufacturing factory) can be adopted. In addition, a part of the processes of the assembling method of the recording device 1 is performed at the manufacturing factory, and the other processes can be performed at the installation location.

In the recording device 1, the sending device 13 and the winding device 17 are supported by the supporting leg 71 via the base plate 73. The base plate 73 is continuous between the sending device 13 and the winding device 17, and thus the relative position between the sending device 13 and the winding device 17 is determined based on the base plate 73. As described above, in the embodiment, the positional accuracy of the base plate 73 with respect to main body portion 7 is maintained to be high. Therefore, in comparison with the configuration in which the sending device 13 and the winding device 17 are attached to the supporting leg 71 via different components, it is easy to improve the relative positional accuracy between the sending device 13 and the winding device 17. Thus, according to the recording device 1, it is easy to improve the positional accuracy of the medium M in the transport path F from the sending device 13 to the winding device 17.

In the recording device 1, since the angle of the main body portion 7 with respect to the supporting leg 71 can be adjusted, the angle of the main body portion 7 with respect to the medium M can be adjusted.

In addition, in the recording device 1, the guide portion 5 is also supported by the supporting leg 71 via the base plate 73. The base plate 73 is continuous between the sending device 13, the guide portion 5, and the winding device 17, and thus the relative position between the sending device 13, the guide portion 5, and the winding device 17 is determined based on the base plate 73. As described above, in the embodiment, the positional accuracy of the base plate 73 with respect to the main body portion 7 is maintained to be high. Therefore, it is easy to improve the relative positional accuracy between the sending device 13, the guide portion 5, and the winding device 17. Thus, according to the recording device 1, it is easy to further improve the positional accuracy of the medium M in the transport path F from the sending device 13 to the winding device 17.

In the recording device 1, the tension applying mechanism 41 is also supported by the supporting leg 71 via the base plate 73. The base plate 73 is continuous between the sending device 13, the guide portion 5, the tension applying mechanism 41, and the winding device 17, and thus the relative position between the sending device 13, the guide portion 5, the tension applying mechanism 41, and the winding device 17 is determined based on the base plate 73. As described above, in the embodiment, the positional accuracy of the base plate 73 with respect to the main body portion 7 is maintained to be high. Therefore, it is easy to improve the relative positional accuracy between the sending device 13, the guide portion 5, the tension applying mechanism 41, and the winding device 17. Thus, according to the recording device 1, it is easy to further improve the positional accuracy of the medium M in the transport path F from the sending device 13 to the winding device 17. As a result, for example, it is possible to easily avoid the positional deviation of the medium M due to the unbalanced tension.

In the embodiment, a configuration in which the main body portion 7 is supported by the supporting leg 71 via the top plate 87 is adopted. However, the configuration of supporting the main body portion 7 is not limited thereto. As the configuration of supporting the main body portion 7, for example, a configuration in which the main body portion 7 is supported by the supporting leg 71 via the base plate 73 can be adopted. In other words, a configuration in which the main body portion 7 is attached to the base member is adopted. According to the configuration, the number of components interposed between the base plate 73 and main body portion 7 can be reduced, and therefore, it is easy to further improve the relative positional accuracy between the main body portion 7, the sending device 13, the guide portion 5, the tension applying mechanism 41, and the winding device 17. Thus, according to the recording device 1, it is easy to further improve the positional accuracy of the medium M with respect to the recording head 11 in the transport path F from the sending device 13 to the winding device 17. As a result, it is easy to improve the quality of recording on the medium M.

In short, according to the invention, the components relating to the transportation of the medium M are attached to a common member such as the base member. Therefore, it is possible to suppress the disagreement between the length of the transport path F on one end side in the width direction (direction intersecting the transport direction) of the medium M and the length of the transport path F on the other end side in the width direction of the medium M. In other words, it is possible to reduce the lateral difference of the transport amount of the medium M.

### REFERENCE SIGNS LIST

1 Recording device
3 Support base portion
5 Guide portion
7 Main body portion
11 Recording head
13 Sending device
13A Holding portion
15 Transporting device
15A, 15B Roller
17 Winding device
19 Carriage
31 Roll
31A Core tube
32 Roll
32A Core tube
35 Control unit
41 Tension applying mechanism
43 Arm member
45 Tension roller
71 Supporting leg
73, 73A, 73B Base plate
75, 75A, 75B Leg portion
77 Connecting plate
81, 81A, 81B Foot portion
83, 83A, 83B Support
85, 85A, 85B Arm portion
87, 87A, 87B Top plate
91 Supporting point
101 Main body case
103 Base portion
105 Connecting member
107 Connecting member
109 Surface plate
F Transport path
M Medium

1. A liquid ejecting apparatus comprising:
an unwinding unit that holds a roll-shaped medium and unwinds the held medium;
an ejecting unit that ejects liquid onto the medium unwound from the unwinding unit;
a winding unit that winds the medium onto which the liquid is ejected; and
a base member to which the unwinding unit and the winding unit are attached.

2. The liquid ejecting apparatus according to claim 1, further comprising:
a transporting unit that is disposed between the unwinding unit and the winding unit and transports the medium.

3. The liquid ejecting apparatus according to claim 1,
wherein, in a plan view of the liquid ejecting apparatus, the ejecting unit is positioned between the unwinding unit and the winding unit.

4. The liquid ejecting apparatus according to claim 1, further comprising:
a main body portion that includes the ejecting unit; and
an angle adjusting unit that adjusts an angle of the main body portion.

5. The liquid ejecting apparatus according to claim 1, further comprising:
a main body portion that includes the ejecting unit,
wherein the main body portion is attached to the base member.

6. The liquid ejecting apparatus according to claim 1, further comprising:
a medium supporting portion that supports the medium,
wherein the medium supporting portion is attached to the base member.

7. The liquid ejecting apparatus according to claim 6,
wherein a heater is provided to the medium supporting portion.

8. The liquid ejecting apparatus according to claim 1, further comprising:
a tension adjusting unit that adjusts tension applied to the medium,
wherein the tension adjusting unit is attached to the base member.

9. An assembling method of a liquid ejecting apparatus including
an unwinding unit that holds a roll-shaped medium and unwinds the held medium;
an ejecting unit that ejects liquid onto the medium unwound from the unwinding unit; and
a winding unit that winds the medium onto which the liquid is ejected, the method comprising:
attaching the unwinding unit and the winding unit to a base member.
